(19) United States
(12) Patent Application Publication
(10) Pub. No.: US 2026/0257184 A1
(43) Pub. Date: Sep. 3, 2026

(54) STRUCTURED PACKING MATERIAL FOR ROTATING PACKED BED CONTACTOR

(71) Applicant: SAUDI ARABIAN OIL COMPANY, Dhahran (SA)

(72) Inventors: Alexander Voice, Detroit, MI (US); Karl Kiebel, Novi, MI (US); Le Zhao, Farmington HIlls, MI (US); William Klemm, Novi, MI (US); Austin Keller, Novi, MI (US)

(73) Assignee: ARAMCO SERVICES COMPANY, Houston, TX (US)

(21) Appl. No.: 19/066,566

(22) Filed: Feb. 28, 2025

(51) Int. Cl. B01J 8/02; B01J 19/32; B33Y 10/00; B33Y 50/00; B33Y 80/00

(52) U.S. Cl. CPC B01J 8/0292; B01J 19/32; B33Y 10/00; B33Y 50/00; B33Y 80/00; B01J 2208/00938; B01J 2208/028; B01J 2219/326; B01J 2219/3306

(57) ABSTRACT

Described is a packing for gas or liquid contacting applications. The packing includes a porous packing material with tortuous flow paths from an inner diameter to an outer diameter of the packing material. The tortuous flow paths are in the form of a mathematically-defined periodic surface having a packing density that varies from the inner diameter to the outer diameter.

### BACKGROUND

Gas-liquid contactors are typically arranged as vertical columns. The vertical column relies on gravity to draw liquid from the top of the column to the bottom of the column, while gas flows counter currently from bottom to top. The vertical columns of gas-liquid contactors can be large, costly, and susceptible to flooding, which is a phenomenon where liquid becomes entrained in the gas exiting the top of the column due to high relative velocity. Furthermore, turbulence and mixing in the liquid phase relies primarily on gravitational forces acting on liquid droplets and rivulets. This presents a limitation to liquid side mass transfer and packing wetting or “effective” (i.e., wetted) area, which brings gas and liquid in contact and, therefore, participates in mass transfer.

In post-combustion CO₂ capture processes using the predominant amine scrubbing thermal swing absorption process, gas-liquid contactors are used to facilitate mass transfer from a CO₂-containing exhaust gas stream to an amine-based solvent with affinity for CO₂ due to acid base chemistry. The absorption process is mass-transfer limited with reaction of CO₂ in the boundary layer. Most of the mass transfer resistance occurs in the liquid phase, thus the absorption rate and, ultimately, the size of the absorber are sensitive to the chemical reaction rate (e.g., solvent dependent), physical phenomena (e.g., turbulence, mixing) in the liquid phase, and the area available for mass transfer. Since the absorber is the largest and most costly equipment used in CO₂ capture processes, enhancement of the effective area and liquid side mass transfer for CO₂ absorption is significant for improving performance and reducing the cost of CO₂ capture.

A packed bed is a hollow tube or vessel packing material, or packing, positioned inside the packed bed. The packed bed improves contact between two phases in a chemical process. When used to perform separation processes, the packing may be structured to force fluids to take complicated paths through the packing. The fluids wet the surface of the packing in the paths, and vapors pass across the wetted surfaces, allowing mass transfer to occur. Various packing materials have different surface areas and void spaces, which impact performance of the packing.

A rotating packed bed (RPB) comprises packing mounted on a horizontal or vertical shaft (rotor), casing, and a liquid distributor. Typically, the rotor is enclosed in the casing, and the liquid distributor injects liquid into the center of the packing. The acceleration improves micro-mixing and produces a higher gas-liquid interfacial surface area accessibility compared to conventional packed beds. During operation, gas and liquid may flow though the RPB co-currently, counter-currently, or cross-currently. In the counter- or co-flow configuration, the gas and liquid travel radially through the RPB.

RPBs can significantly improve CO₂ absorption since the centrifugal motion of the bed can generate shear forces in the liquid which are much greater than the equivalent gravitational forces in stationary contactors. These shear forces create mixing and turbulence in the liquid phase, enhancing the mass transfer coefficient. Additionally, the shear forces cause the liquid to spread out on the packing, increasing effective area and reducing diffusion path lengths. Lastly, impingement of liquid on the RPB packing at high velocity may create fine droplets with very high specific area (interfacial area per unit volume). All of these effects improve mass transfer allowing a significant reduction in the absorber size.

On the other hand, there are several challenges with RPBs which may limit their usefulness and commercial potential. First, RPBs consume power used to overcome friction from the seals around the drive shaft as well as to accelerate the liquid from an angular velocity of zero, when it enters, to the angular velocity of the RPB when it exits. Second, the greater complexity of RPBs relative to static contactors may create operational issues and increase costs related to ancillary components, such as the electric motor, wiring, and controls to spin the RPB. Lastly, the nature of gas and liquid flow radially through a cylindrical contactor means that, unlike in a static counter-flow column in which gas and liquid flow vertically, the gas and liquid flux (i.e., flow rate per unit flow area) vary with the flow path. This challenge persists regardless of whether the RPB is set up as counter-flow, co-flow, or cross-flow, or whether the RPB is oriented vertically (rotational axis orthogonal to the ground) or horizontally (rotational axis parallel to the ground).

Of these challenges, the first appears to be manageable as the absorber is operated at low pressure and, thus, tolerance and friction around seals is low. Furthermore, optimal speeds for the RPB are in the range of 100-400 RPM, which is relatively low even for small applications. For larger applications, the optimal speed may be even lower since the shear forces which promote mass transfer and effective area enhancement in RPBs are a function of linear speed, which is directly proportional to both radius and angular velocity. The low pressure and low speed indicate that RPBs can be very simple with low power requirements on the order of less than $1/tonne CO₂.

Regarding the last challenge, namely the change in superficial gas velocity as a function of radius, even for smaller systems the change can be quite dramatic, such as a factor of ~7 change in superficial gas velocity between the inner diameter (ID) and the outer diameter (OD) of the RPB. For instance, an RPB may be designed with an ID of 80 millimeters (mm) and an OD of 570 mm, where OD/ID=7.1. For larger systems designed to handle higher gas flows and having higher capture rates, the change may be even more dramatic. Conventional structured and random packings are designed to operate in a particular range of F-factor, defined as the gas velocity times the square root of the gas density. The F-factor range is approximately 0.5-2.5 (a factor of 5), and partially depends on the packing. At a high F-factor (i.e., high gas velocity), pressure drop may be too high, increasing operating costs.

Flooding may also occur when liquid becomes entrained with gas due to high relative velocity. At low gas velocity, channeling and poor gas distribution may occur, and gas side mass transfer resistance may increase. Thus, it is desirable for the gas velocity to stay in an optimal range. For counter-current RPBs, the ratio between the inner radius (where liquid enters and gas exits) and the outer radius (where gas enters and liquid exits) may be quiet large, since longer gas travel path lengths may be necessary to achieve a desired capture rate. Regardless, it is desirable to keep the gas velocity in a fairly narrow, optimal range, where pressure drop is high enough to avoid channeling, ensure good gas distribution, and minimize gas side mass transfer resistance. However, the pressure drop needs to be low enough so as to not cause flooding or increase operating costs. Thus, the change in gas velocity between the inner and outer radiuses of the RPB (the ratio of which is proportional to the ratio of the radius) presents a challenge for designing RPBs and ensuring that the packing is both well-utilized for mass transfer and not overly restrictive for pressure drop.

FIGS. 1A and 1B illustrate views of an exemplary RPB 100 according to prior art. The RPB 100 has a static chamber 102, a gas inlet 104 located at the top of the static chamber 102, a gas outlet 106 connected with a central inner part of the RPB 100, a liquid inlet 108, a liquid distributor 110, which splashes or sprays liquid from the central inner part of the RPB 100, a liquid outlet 112 located at the bottom of the static chamber 102, a rotating shaft 114, and packing 116. In this type of RPB, the packing density is typically uniform within each layer.

As explained previously, the change in gas velocity between the inner and outer radiuses of the RPB presents a challenge for designing RPBs. A previous solution to this challenge is the use of concentric layers of packing 116a, 116b, 116c, and 116d, as shown in FIG. 1A. The inner layers (e.g., 116a, 116b) may be formed to be relatively open, have a lower specific area, and a lower pressure drop per unit length at a given gas velocity. The outer layers (e.g., 116c, 116d) may be formed to be more intricate and/or closed, have a higher specific area, and a higher pressure drop per unit length at a given gas velocity. Thus, the concentric layers/rings of packing may have distinct configurations from one another, providing different properties. Because the gas velocity is not constant as the gas travels radially through a RPB, the concentric layers of packing 116a, 116b,116c, and 116d may be designed to achieve the same, or a similar, pressure drop per unit length through each nested layer.

However, assuming each layer has a uniform geometry, the pressure drop per unit length may still change between the inner and outer radius of each layer. Adding more layers while reducing the radial length (i.e., difference between inner radius and outer radius) of each layer is one option. Yet additional layers add complexity to assembling and installing packing modules as well as balancing the rotor. Furthermore, discreet boundaries between packing layers (e.g., 116b and 116c) may create regions of sub-optimal wetting and mass transfer before the flow films are able to fully develop. Nonetheless, a RPB comprised of multiple concentric layers of packing, where the outer layers (e.g., 116c and 116d) are more dense, intricate, and have higher pressure drop per unit length than the inner layers (e.g., 116a and 116b), will outperform a RPB with a single, uniform geometry packing material.

FIG. 2 depicts another exemplary RPB 100, where the packing 116 is represented by a crosshatch pattern. Since the gas moves radially, gas velocity is a function of the packing radius. Gas velocity is highest at the inner radius and lowest at the outer radius. If pressure drop per unit length (dP/L) is to be maintained, then packing density needs to vary continuously in the radial direction.

Given the issues of complexity of adding multiple layers as well as the change in gas velocity between the inner and outer radius of each layer, a packing material having a density that varies continuously from an inner radius/diameter to an outer radius/diameter of the packing material is needed. Continuous variable density packing may ensure that the gas velocity always remains at its optimal value regardless of the radial position, rather than only achieving the optimal velocity at a single point within one or more concentric layers of packing having uniform density.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a packing for gas or liquid contacting applications. The packing comprises a porous packing material having a plurality of tortuous flow paths from an inner diameter to an outer diameter of the packing material. The plurality of tortuous flow paths are in a form of a mathematically-defined periodic surface, and the periodic surface has a packing density that varies from the inner diameter to the outer diameter.

In another aspect, the packing density varies continuously from the inner diameter to the outer diameter, and the packing density is higher at the outer diameter than at the inner diameter.

In another aspect, the periodic surface is mathematically defined using one or more periodic- or fractal-based equations in which at least one of a surface thickness, a void fraction, a surface area, or a pressure drop per unit length is varied.

In another aspect, the periodic surface is a triply-periodic minimal surface.

In another aspect, the periodic surface has a period ranging from approximately 0.1 millimeters to approximately 10 millimeters.

In another aspect, the periodic surface has a specific surface area ranging from approximately 100 m²/m³ to approximately 4000 m²/m³.

In another aspect, the periodic surface is defined by a gyroid equation, a Schwarz P equation, a Schwarz D equation, a Neovius equation, a Schoen I-Weaire-Phelan equation, a Fischer-Koch equation with rhombohedral symmetry, or a Schwarz crossed layers of parallel planes surface.

In another aspect, a plurality of holes in the porous packing material are aligned such that an axis extending through a set of aligned holes is at an angle between approximately 30° and 60° relative to a direction of gas flow.

In one aspect, embodiments disclosed herein relate to a method for producing a packing. Using one or more periodic equations, a periodic surface for a packing having an inner diameter and an outer diameter is mathematically defined. A thickness of the periodic surface is specified in order to translate the periodic surface into a three-dimensional solid body. The packing having the periodic surface is produced via additive manufacturing, where the packing is comprised of a porous packing material having a plurality of tortuous flow paths from the inner diameter to the outer diameter of the packing material. The plurality of tortuous flow paths are in a form of the periodic surface, a packing density of the periodic surface varies from the inner diameter to the outer diameter, and the packing density is greater at the outer diameter than at the inner diameter.

In another aspect, the packing density varies continuously from the inner diameter to the outer diameter.

In another aspect, at least one of a surface thickness, a void fraction, a specific surface area, a liquid holdup, and a pressure drop per unit length of the packing is varied in a direction of fluid travel.

In another aspect, the one or more periodic equations comprises one or more of a gyroid equation, a Schwarz P equation, a Schwarz D equation, a Neovius equation, a Schoen I-Weaire-Phelan equation, and a Fischer-Koch equation with rhombohedral symmetry, and a Schwarz crossed layers of parallel planes surface.

In another aspect, the periodic surface is a triply-periodic minimal surface.

In another aspect, a permeability, the pressure drop, and the liquid holdup of the periodic surface are estimated using a Kozeny-Carman equation, a Darcy-Forchheimer equation, and a Burns correlation, respectively.

In another aspect, a pressure drop per unit length is determined as a function of the packing density and a superficial gas velocity. The pressure drop per unit length is fit to the one or more periodic equations such that a geometry of the packing is varied to maintain a constant pressure drop.

In another aspect, the packing is positioned inside of a cylindrical rotating packed bed such that an interfacial area between two fluid phases is created, where at least one of the fluid phases passes radially through the cylindrical rotating packed bed, transiting from the inner diameter to the outer diameter, or from the outer diameter to the inner diameter.

In another aspect, a liquid holdup is determined as a function of the packing density, a gas velocity, a liquid velocity, and a rotational speed. The liquid holdup is fit to the one or more periodic equations such that a geometry of the packing is varied to maintain a constant liquid holdup without changing a local superficial gas velocity.

Any combinations of the various embodiments and implementations disclosed herein can be used in a further embodiment, consistent with the disclosure. Other aspects and advantages of the claimed subject matter will be apparent from the following description and the appended claims.

### BRIEF DESCRIPTION OF DRAWINGS

FIGS. 1A and 1B illustrate a rotating packed bed (RPB) according to prior art.

FIG. 2 illustrates an RPB according to prior art.

FIGS. 3A-3C illustrate examples of gyroid periodic structures according to one or more embodiments of the present disclosure.

FIG. 4 illustrates examples of various triply periodic minimal surface (TPMS) structures according to one or more embodiments of the present disclosure.

FIG. 5A illustrates specific area values of a gyroid structure as a function of gas velocity and period according to one or more embodiments of the present disclosure.

FIG. 5B illustrates pressure drop values of a gyroid structure as a function of gas velocity and period according to one or more embodiments of the present disclosure.

FIG. 6 illustrates an example of a continuous variable gyroid packing structure according to one or more embodiments of the present disclosure.

FIG. 7 is a log-log plot illustrating a calculated gyroid period as a function of radial position according to one or more embodiments of the present disclosure.

FIG. 8 illustrates a modeling tool that allows specification of a surface according to one or more embodiments of the present disclosure.

FIG. 9A illustrates void fraction as a function of surface thickness and cell size according to one or more embodiments of the present disclosure.

FIG. 9B illustrates specific surface area as a function of cell size according to one or more embodiments of the present disclosure.

FIG. 10A illustrates the relationship between differential pressure (dP) and gas velocity for various gyroid cell sizes according to one or more embodiments of the present disclosure.

FIG. 10B illustrates the relationship between pressure drop and gas velocity for various gyroid cell sizes according to one or more embodiments of the present disclosure.

FIG. 11A illustrates the relationship between pressure drop and packing area for various flow rates according to one or more embodiments of the present disclosure.

FIG. 11B illustrates the relationship between pressure drop and void fraction for various flow rates according to one or more embodiments of the present disclosure.

FIG. 12 illustrates total packing area as a function of radial position according to one or more embodiments of the present disclosure.

FIG. 13A illustrates the relationship between gyroid cell size and radial position for various gyroid structures according to one or more embodiments of the present disclosure.

FIG. 13B illustrates the relationship between the gyroid coefficient and radial position for various gyroid structures according to one or more embodiments of the present disclosure.

FIG. 14 illustrates a wedge structure according to one or more embodiments of the present disclosure.

FIG. 15 illustrates a flow diagram illustrating a method for producing a structured packing material for use in a RPB according to one or more embodiments of the present disclosure.

FIG. 16 illustrates a computing system according to one or more embodiments of the present disclosure.

FIG. 17 illustrates a variable gyroid RPB according to one or more embodiments of the present disclosure.

FIG. 18 illustrates a variable gyroid RPB according to one or more embodiments of the present disclosure.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

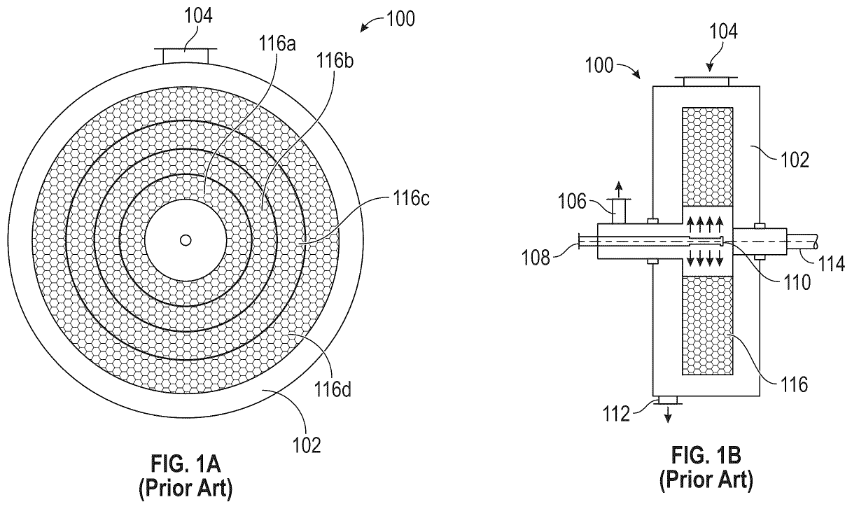

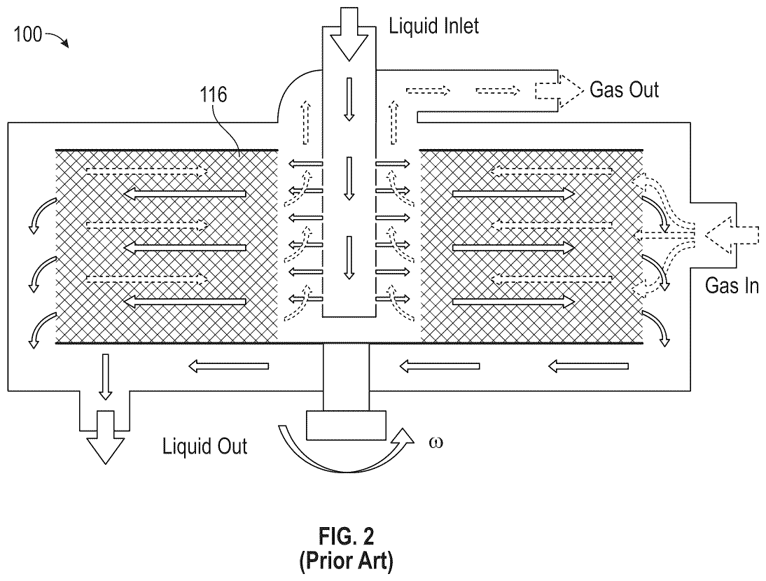

In the following description of FIGS. 1-18, any component described with regard to a figure, in various embodiments disclosed herein, may be equivalent to one or more like-named components described with regard to any other figure. For brevity, descriptions of these components will not be repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a passive soil gas sample system” includes reference to one or more of such systems.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

In one aspect, embodiments disclosed herein relate to a structured packing for use in a rotating packed bed contactor. In one or more embodiments, the structured packing is a packing material having a continuous variable density periodic surface which varies with one or more dimensions of the rotating packed bed. In one or more embodiments, the continuous variable density packing is designed through the use of period-based geometries in which a local void fraction, a local surface area, and a local pressure drop per unit length may be varied radially by controlling one or more parameters. For example, for a given set of conditions (e.g., gas flow, liquid flow), an increase in packing density at each incremental radius may offset a drop in nominal gas velocity, creating a uniform pressure drop (linear change in pressure as a function of radius) and ensuring an optimum regardless of the location in the structure. For the purposes of this disclosure, local refers to a discrete increment, such as a section or zone of packing (e.g., a 1 mm×1 mm×1 mm section or other discrete area or volume that forms a portion of the whole).

In one or more embodiments, the packing comprises a porous packing material having multiple tortuous flow paths from an inner diameter to an outer diameter of the packing material. The tortuous flow paths may be in the form of a mathematically-defined periodic surface. The packing density of the determined periodic surface may vary from the inner diameter to the outer diameter, and a local density of the packing may be greater at the outer diameter than at the inner diameter. In one or more embodiments, the structured packing improves CO₂ absorption into an aqueous amine solution for the purpose of selectively removing CO₂ from a stream, and then heating the amine solution to desorb CO₂ and regenerate the amine solution.

Non-limiting examples of periodic surfaces are listed in Table 1, along with the parameter (or parameters) which may be adjusted to control the packing density of each periodic surface. A periodic surface may be defined as a pattern that is the same across different scales and repeats itself over time. For the purposes of this disclosure, density may refer to the spacing of a repeating unit, the void fraction, or the specific area of a periodic surface. The periodic surface may be defined by a gyroid equation, a Schwarz P equation, a Schwarz D equation, a Neovius equation, a Schoen I-Weaire-Phelan equation, a Fischer-Koch equation with rhombohedral symmetry, or a Schwarz crossed layers of parallel planes surface.

TABLE 1

| Surface type | Parameter to adjust density |
|---|---|
| Gyroid surface | Period |
| Schwarz D and Schwarz | Period |
| P surface | |
| Menger sponge | Number of iterations |
| Sierpinski tetrahedron | Number of iterations |
| Voronoi tessellations | Distribution and density |
| | of seed points |
| Kelvin cells | Size of cell |
| Dendritic structures | Growth parameters and |
| | branching rules |

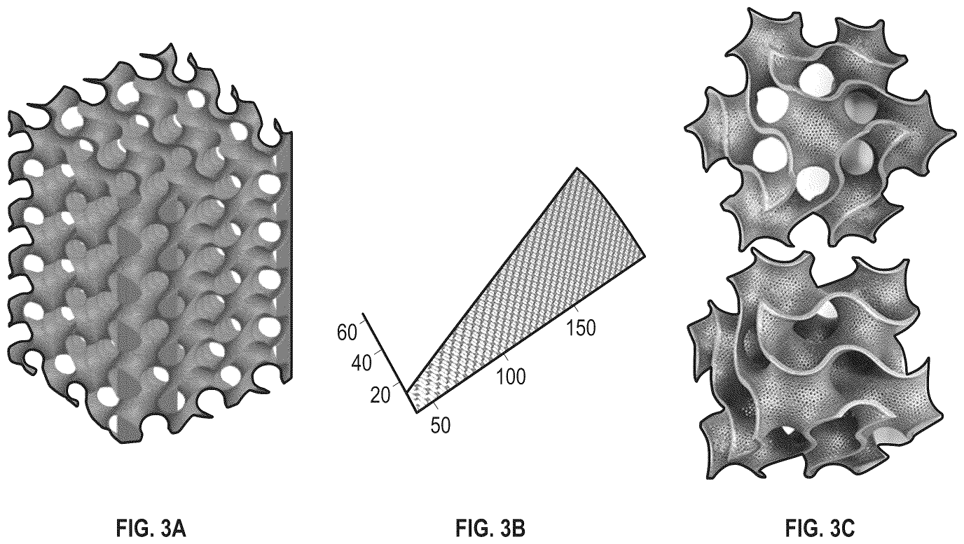

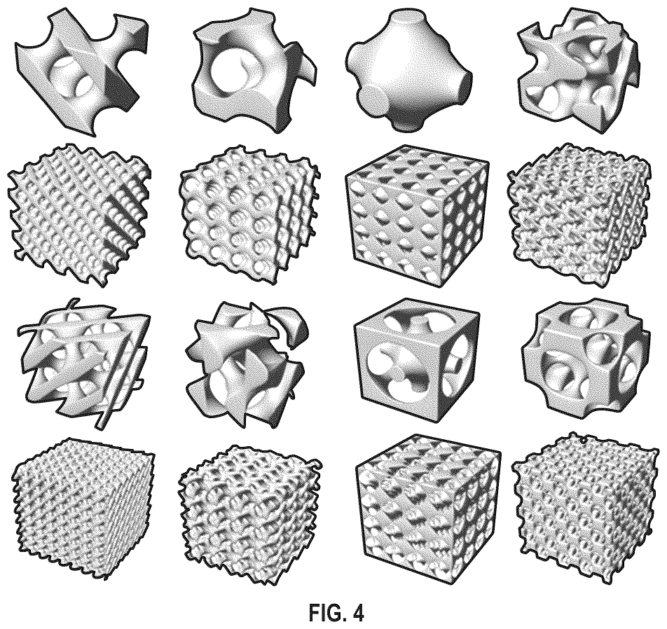

FIGS. 3A, 3B, and 3C depict examples of gyroid structures. The actual inner diameter (ID) and outer diameter (OD) of a given RPB is dependent upon the RPBs application and targets/assumptions. In one or more embodiments, the packing is designed in the shape of a triply periodic minimal surface (TPMS). TPMS structures have smooth surfaces and interconnected frameworks that have a high specific strength and energy absorption capacity. Examples of TPMS structures that may be used as periodic surfaces for packing include, but are not limited to, the periodic surfaces listed in Table 1, IWP (I-graph and wrapped package-graph), primitive, diamond, diamond-type2, Neovius, FKS, and FRD. Any TMPS type structure may be used in designing the structured packing described herein provided that the cell size varies as a function of radius. Non-limiting examples of TMPS cells and the corresponding structures are illustrated in FIG. 4.

In order to maintain constant pressure drop and more effectively utilize outer layers of the packing material, mathematical formulas were created to specify and design a packing media/material such that the cell size of the TMPS varies. The following equations describe gyroid, Schwarz P, and Schwarz D surfaces, where P (period) is defined as a function of radial position and A denotes amplitude. In the equations below, X, Y, and Z represent Cartesian coordinates that may be translated into polar cylindrical coordinates using X=R cos(θ), Y=R sin(θ), and Z=Z.

$$Gyroid : A * ( sin ( \frac{X}{P} ) * cos ( \frac{Y}{P} ) + sin ( \frac{Y}{P} ) * cos ( \frac{Z}{P} ) + sin ( \frac{Z}{P} ) * cos ( \frac{X}{P} ) ) > threshold ( e . g . , 0.1 )$$

$$Schwarz P = A * ( cos ( \frac{Y}{P} ) + cos ( \frac{Z}{P} ) + cos ( \frac{X}{P} ) ) = 0 ; and$$

$$Schwarz D = A * ( sin ( \frac{X}{P} ) * sin ( \frac{Y}{P} ) * sin ( \frac{Z}{P} ) + sin ( \frac{X}{P} ) * cos ( \frac{Y}{P} ) * cos ( \frac{Z}{P} ) + cos ( \frac{X}{P} ) * sin ( \frac{Y}{P} ) * cos ( \frac{Z}{P} ) + cos ( \frac{X}{P} ) * cos ( \frac{Y}{P} ) * sin ( \frac{Z}{P} ) ) = 0.$$

With a cylindrical RPB, the structure will remain uniform and symmetric in the angular and Z (height) direction. Although geometries based on complex mathematics and non-uniform geometry may be difficult to produce using traditional manufacturing methods, additive manufacturing (i.e., three-dimensional (3-D) printing) may be used to manufacture complex geometries with few limitations on complexity or specific characteristics. Additive manufacturing with plastic or metal materials may be utilized to produce the periodic surfaces of the packing, with plastic being a less expensive option. Moreover, overall manufacturing costs for additive manufacturing may be lower than conventional methods. Unlike the production of structured packing modules which must be cut, assembled, and tack welded from larger sheets, additive manufacturing may be fully automated.

Through mathematical analysis, the pressure drop and specific area for a gyroid structure were estimated. The correlation of specific area and pressure drop was used to determine how the gyroid period may be varied as a function of radius to keep pressure drop per unit length constant. The periodic- or fractal-based equations developed from the analysis are for example purposes only and are not intended to be limiting. The dependence of pressure drop and specific area on period is complex and may be verified using computer-aided design (CAD) tools to determine the specific area and void fraction. For instance, computational fluid dynamic (CFD) calculations may be utilized to determine pressure drop and wetted area. The gyroid geometry of a structure may be determined using the following gyroid equation with a threshold value of 0.1.

$$Gyroid : A * ( sin ( \frac{X}{P} ) * cos ( \frac{Y}{P} ) + sin ( \frac{y}{P} ) * cos ( \frac{Z}{P} ) + sin ( \frac{Z}{P} ) * cos ( \frac{X}{P} ) ) > threshold ( e . g . , 0.1 )$$

The specific area and void fraction were calculated directly from the triangulation of the isosurface. Permeability of the gyroid structure was then estimated using the Kozeny-Carman equation, and pressure drop was estimated using the Darcy-Forchheimer equation. As well understood by one skilled in the field of fluid dynamics, the Kozeny-Carman equation is a formula used to calculate the pressure drop of a fluid flowing through a packed bed of solid material. The Darcy-Forchheimer equation is used to model flow in a porous media. The effective particle diameter for the inertial coefficient in the Darcy-Forchheimer equation was estimated assuming a cylindrical geometry using the void fraction and specific area. Gas velocity was varied from about 0.25 to about 2.0 meters (m)/second (s), and the gyroid period was varied from about 0.1 millimeters (mm) to about 10 mm, such as 0.3 mm to 3 mm, to achieve a specific area of 100-2000 m²/m³. In general, the specific area at the inner radius may be between about 100 m²/m³ and about 1000 m²/m³, and the specific area at the outer radius may be between about 1000 m²/m³ and about 4000 m²/m³.

The following correlations were used to describe the relationship between gyroid period and pressure drop, as well as the relationship between pressure drop, gyroid period, and gas velocity. As shown below, substituting the definition of gas velocity, the pressure drop equation may be rearranged to determine the period as a function of radius to maintain constant pressure drop.

$$Gas velocity = U = \frac{{V}_{f}}{{A}_{f}} = \frac{{V}_{f}}{π * D}$$

$$Specific surface area = {a}_{s} = \frac{{A}_{s}}{V} = a * {P}^{b}$$

$$Permeability = K = \frac{{ϕ}^{3}}{{a}_{s} * {( 1 - ϕ )}^{2}}$$

$$Pressure drop per unit length = \frac{Δ p}{Δ L} = \frac{μ * U}{K} + \frac{ρ * {U}^{2}}{β}$$

$$Inertial coefficient = β = \frac{{ϕ}^{3} * {D}_{p}}{1.75 * ( 1 - ϕ )}$$

$$Effective particle diameter = {D}_{p} = \frac{4 * ϕ}{{a}_{s}}$$

$$\frac{Δ p}{Δ L} = pressure drop per unit length$$

TABLE 2

| Variable | Measurement |
|---|---|
| U | Gas Velocity |
| A_{f} | Gas Flow Area |
| V_{f} | Gas Volumetric Flow Rate |
| aₛ | Specific Area = Surface Area Per Unit |
| | Volume of Packing |
| Aₛ | Total Surface Area of Packing |
| V | Packing Volume |
| P | Period of Fractal Pattern |
| Dₚ | Effective Particle Diameter |

$$Specific area correlation : {a}_{s} = a * {P}^{b}$$

$$Pressure drop correlation : \frac{Δ p}{Δ L} = c * {P}^{d} * {U}^{e}$$

$$Dependence on period : P = {( \frac{c * {U}^{e}}{\frac{Δ p}{Δ L}} )}^{1 / d} = {( \frac{c * {( \frac{V}{π * D} )}^{e}}{\frac{Δ p}{Δ L}} )}^{1 / d}$$

$$a , b , c , d , e = regressed constants$$

TABLE 3

| Empirical | Empirically estimated value |
|---|---|
| Parameters | for gyroid geometry |
| a | 550 |
| b | −0.863 |
| c | 0.56 |
| d | −0.771 |
| e | 2.0 |

The empirical parameters (constants) from the above equations may be used to calculate the period as a function of radius to maintain constant pressure drop. The constants are generic for any geometry. Radial flow through a disc/cylinder may be determined as follows:

$${A}_{f} ( r ) = 2 * π * r * H ,$$

where r is the radial position, H is the height of the cylinder, and A_{f} is the gas flow area.

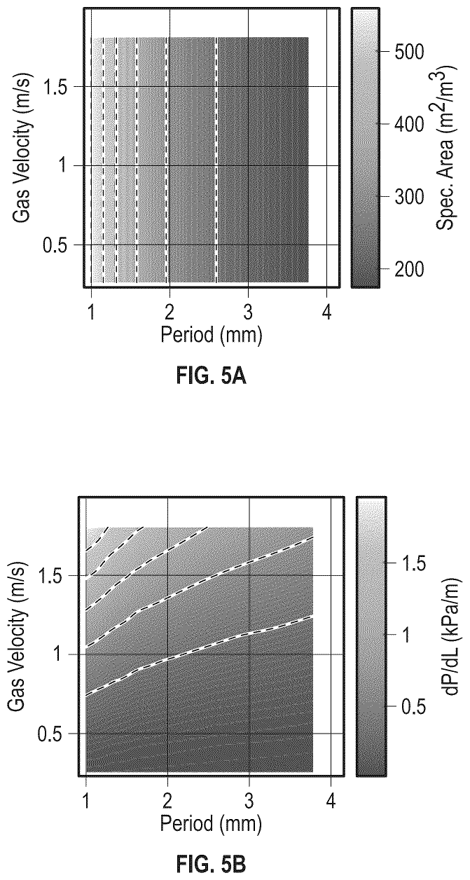

FIG. 5A illustrates specific area values of a gyroid structure as a function of gas velocity and period. As shown, specific area decreases as the period increases. FIG. 5B illustrates pressure drop values of a gyroid structure as a function of gas velocity and period. It is evident from FIG. 5B that pressure drop decreases as period increases, and pressure drop increases as gas velocity increases.

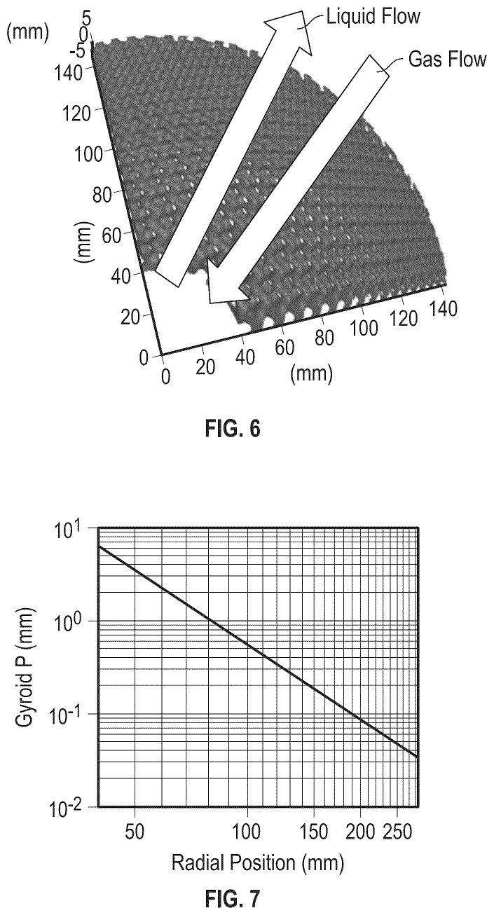

FIG. 6 illustrates an example of a continuously variable gyroid packing structure according to one or more embodiments of the present disclosure. The gyroid density increases with radius to compensate for decreasing gas flow. For the purposes of this disclosure, continuously variable may describe a parameter value, such as density, continuously increasing from inner diameter to outer diameter or continuously decreasing from inner diameter to outer diameter. Additionally, a parameter value may vary continuously between two (or more) points (e.g., point A, point B) or increments within the packing. For instance, a parameter value may vary continuously up or down in relative value from increment to adjacent increment. In one or more embodiments, a parameter value continuously increases in value with each increment. In one or more other embodiments, a parameter value continuously decreases in value with each increment. For instance, a surface thickness, a void fraction, a specific surface area, a liquid holdup, and/or a pressure drop per unit length of the packing may be varied in a direction of fluid travel. When an interfacial area is created between two fluid phases in a cylindrical RPB, at least one of the fluid phases may pass radially through the cylindrical RPB, transiting from the inner diameter to the outer diameter, or from the outer diameter to the inner diameter.

FIG. 7 is a log-log plot illustrating a calculated gyroid period as a function of radial position according to one or more embodiments of the present disclosure. For practical applications, the total pressure drop at a designated gas flow rate, as well as the relationship between gyroid period, pressure drop, and specific area may be verified using computational fluid dynamics.

The purpose of the gyroid example above is to describe a simplified approach for estimating pressure drop and show how the gyroid period may be varied to maintain the same pressure drop as radial position increases and gas velocity decreases. Empirically, in this example, the pressure drop was found to vary with the square of the gas velocity (e=2), and with the period to the −0.771 power (d=−0.771). To determine the period to maintain constant pressure drop, these exponents were combined such that the period is proportional to radius to the e/d, or 2/−0.771=−2.59 power. A smaller gyroid period at the outer radius provides a greater pressure drop (i.e., pressure driven gas flow with frictional losses due to interaction of the gas with the packing and walls), compensating for the lower gas velocity. The pressure drop applies to the packing regardless of counter-current, co-current, or cross-current flow architectures.

In one or more embodiments, the structured packing material described herein is used for creating an interfacial area between a gas and a liquid stream for the purposes of absorption or stripping in a RPB contactor. The geometry of the structured packing material may consist of a fractal pattern, and the density of the structured packing material may vary with one or more dimensions of the RPB. Pressure drop may be estimated using the geometrical features of the packing, such as the void fraction and the surface area. The Kozeny-Carman equation and the Darcy-Forchheimer equation may be used to determine the pressure drop as a function of the geometry of the packing material and the gas velocity. The empirical relationship may then be used to design a packing with a constant pressure drop. In one or more embodiments, the fractal structure is designed such that repeating holes in the structure are aligned such that the axis extending through aligned holes is at an approximate 30° to 60° angle relative to the direction of gas flow to avoid gas channeling. To align the holes, the whole gyroid structure may be rotated mathematically, or the desired shape (e.g., wedge, disc) may be rotated relative to the gyroid pattern.

Similar analyses may be applied to Schwarz and other fractal geometries to determine the relationship between parameters that control the density of the structure and the pressure drop. Some geometries may have more than one parameter, which may be varied to maintain the same pressure drop per unit length with decreasing gas velocity. For example, in the case of a gyroid, the period, amplitude, and thickness of the surface (since the gyroid equation defines a surface and not a solid body) will all change the pressure drop and specific area.

For continuously variable density packing, a single layer or multiple concentric layers may be used depending on the desired design. For instance, multiple layers may have advantages, such as redistribution of liquid and/or ease of manufacturing (e.g., 3-D printer size). Designing and producing a structured packing is challenging using traditional means. However, a packing may be designed and 3-D printed with the gas and liquid flow direction in mind to provide the required area and pressure drop.

The invention described herein allows specification of a surface using a mathematical formula, followed by thickening of the surface into a solid body which may be physically produced, such as through 3-D printing. The original surface has a 0 thickness so that the thickness may be specified to ensure that the packing is thick enough to be printed (i.e., greater than 0.1 mm) and for a 3-D printer nozzle to render the features properly. Additionally, the thickness of the surface must be sufficient to provide mechanical integrity. In one or more embodiments, the thickness of a produced RPB structure is in a range of about 0.1 mm to about 1 mm. Generally, thinner structures will be advantageous for maximizing specific area while minimizing pressure drop. However, in some cases it may be necessary to specify a minimum period, or other parameter, to ensure that the structure remains manufacturable/printable and structurally sound.

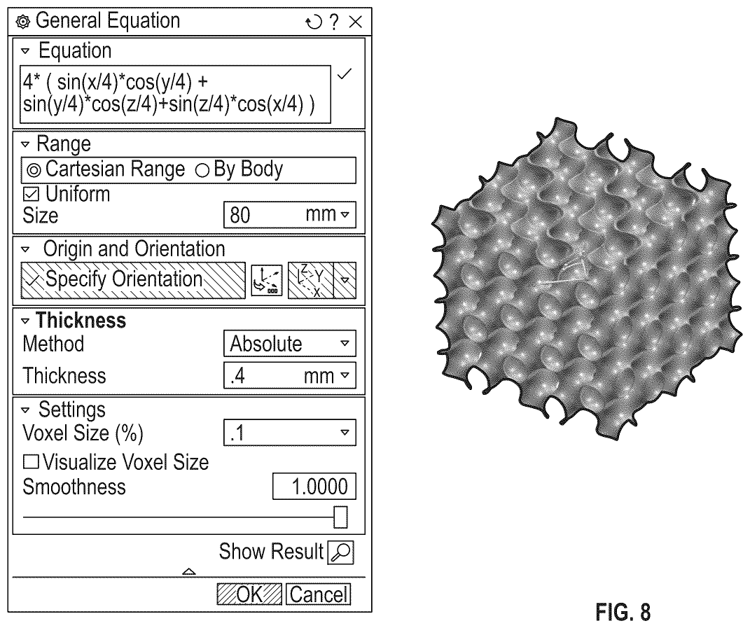

In one or more embodiments, gyroid patterns may be drawn using design software, such as CAD software. For instance, a vertically-oriented cylindrical form may be designed to model gas entering the bottom and exiting the top. FIG. 8 illustrates an NX implicit modeling tool that may allow specification of the surface shown using a specific mathematical formula to control the features of the surface. A modeling tool allows the features to be adjusted to achieve the desired properties of the surface (i.e., surface area and pressure drop). For instance, the gyroid density (cell size) may be varied to produce a total packing area of between about 200 m²/m³ and about 2000 m²/m³. In one or more embodiments, some applications may require a total packing area greater than 2000 m²/m³.

Geometric properties (e.g., void fraction, specific surface area) may be correlated with the cell size in the gyroid equation for a given surface thickness. Note that surface area is a function of gyroid cell size, whereas void fraction is a function of surface thickness and gyroid cell size. Dry pressure drop may be estimated using computational fluid dynamics (CFD). Single variable relationships may be determined for area and void fraction, void fraction and pressure drop (dP), and gas velocity and dP. A multi-variable correlation may be used to determine dP/L (local pressure drop per unit length) as a function of void fraction and gas velocity. The multi-variable correlation may also be determined for specific area A=f(dP/L,U) so that the correct local specific area A may be determined based on the target pressure drop (dP/L) and local superficial gas velocity (U), which is the cross-sectional area divided by volumetric flow rate. The equation which correlates the parameters in the gyroid equation with the gyroid surface area may then be combined with the correlation between surface area, gas velocity, and pressure drop to specify the geometry using the gyroid equation as a function of radial position. Since gas velocity decreases with increasing radial position, this will result in higher gyroid density (i.e., lower cell length (L(r) parameter)).

For the purposes of this disclosure “superficial gas velocity” refers to the gas velocity given the total area in a gas flow direction. The superficial gas velocity value does not take into account that some of the total area is blocked such that the superficial gas velocity may be lower than the “actual” gas velocity, which is different at every point in space. For instance, for a pipe velocity, the actual velocity is lowest near the wall of the pipe, but the superficial gas velocity is constant because the pipe geometry and cross-sectional area is constant in the flow direction. For flows through geometries with a changing cross-sectional area, there is a “local” superficial gas velocity. The local superficial gas velocity refers to the gas velocity calculated using the “local” cross-sectional flow area, which is a function of some dimension (e.g., radius). Pressure drop may decrease as cross-sectional area increases and superficial gas velocity decreases.

The relationship between gas velocity and pressure drop for different geometries may be studied by changing the flow rate through a given geometry having a constant flow area, such as a cylinder with flow in the Z (height) direction. A CFD model may be used to model the porous media and determine the pressure drop as a function of media density and gas velocity. Given a disc where gas is flowing in the radial direction, the gas flow area and gas velocity are changing. The “local” gas velocity at every point in the radial direction is different than at the inlet or outlet, since the gas flow area is a function of radius according to:

$$A = π * 2 * R * H .$$

Therefore, the packing may be designed so that the density of the packing increases as the local superficial gas velocity decreases, maintaining a constant pressure drop per unit length.

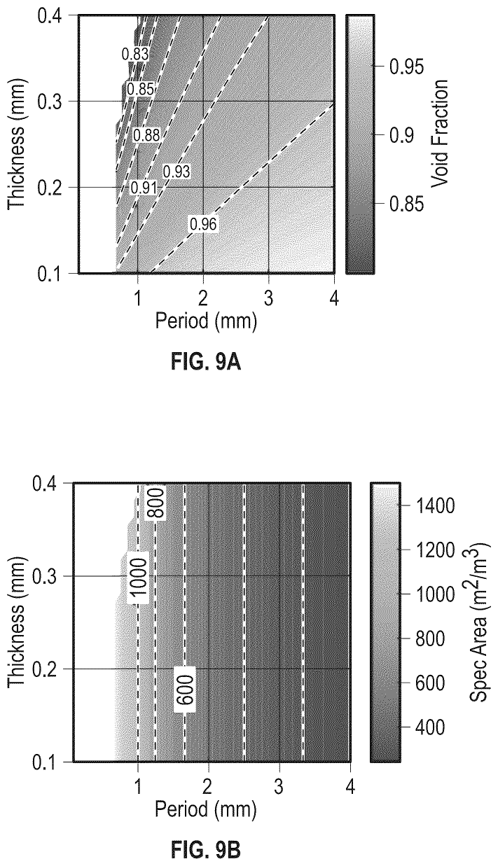

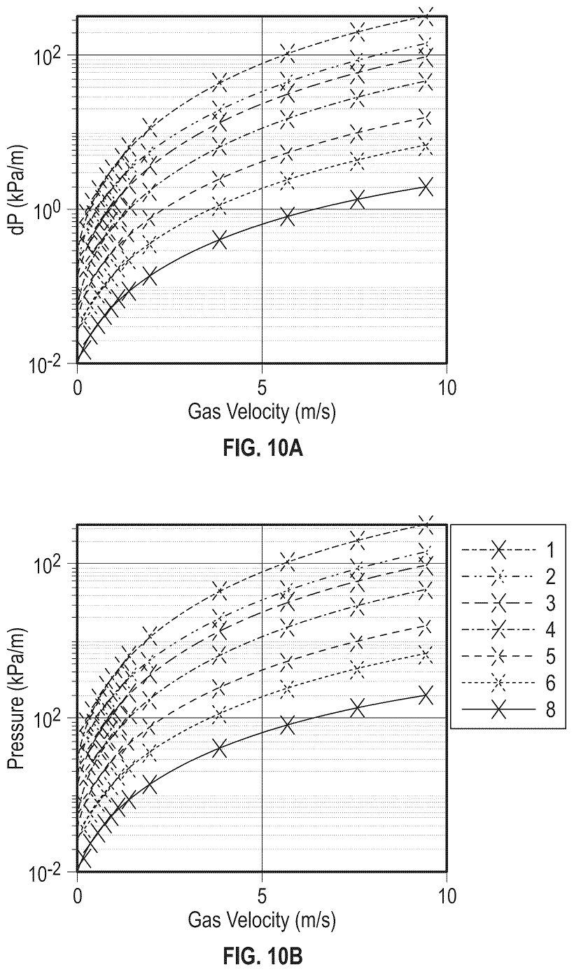

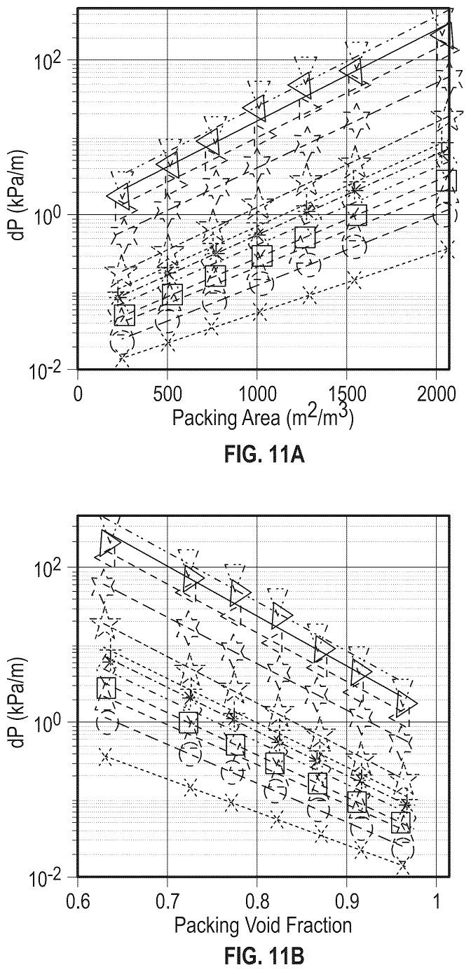

As illustrated in FIG. 9A, for gyroids and other triply-periodic minimal surfaces, void fraction is a function of surface thickness and period (cell size). FIG. 9B shows that specific surface area is a function of only the period. FIGS. 10A and 10B depict the relationship between (1) differential pressure (dP) and gas velocity and (2) pressure drop and gas velocity, respectively, for various gyroid cell sizes represented by different curves/lines in the plots. FIGS. 11A and 11B show the correlation of pressure drop with packing area and void fraction, respectively, for various flow rates. The various flow rates are represented by different curves/lines in the plots.

Since the data is well correlated, the data may be used to accurately determine desired surface area as a function of radius (r). Since area is correlated with cell size, L in the gyroid equation below may then be replaced with L=L(r).

$$sin ( \frac{2 π * x}{L} ) * cos ( \frac{2 π * y}{L} ) + sin ( \frac{2 π * y}{L} ) * cos ( \frac{2 π * z}{L} ) + sin ( \frac{2 π * z}{L} ) * cos ( \frac{2 π * x}{L} )$$

$$L = unit cell length$$

$$Coefficient ( C ) = 2 * π * L$$

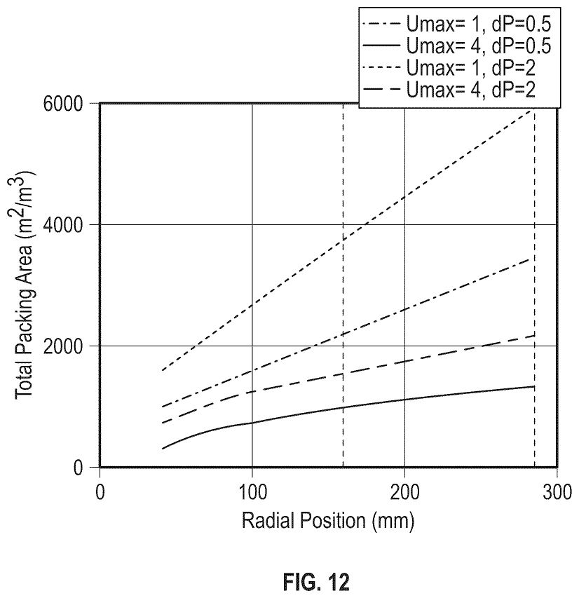

FIG. 12 illustrates total packing area as a function of radial position at different Uₘₐₓ and dP values. Uₘₐₓ represents the superficial gas velocity at the inner radius. The exact Uₘₐₓ value is dependent upon the design of the RPB. For instance, the Uₘₐₓ value may be between 1 meter per second (m/s) and 10 m/s, with values between 1 m/s and 4 m/s being typical. Stationary packed columns typically have a dP value between 0.05 kPa/m and 0.5 kPa/m due to flooding limits. However, because RPBs can tolerate higher gas velocities without flooding, a higher limit of 2 kPa/m may be possible, with a maximum of about 20 kPa/m. The exact selection of Uₘₐₓ and dP values depends on many factors, and the values recited above are not intended to be limiting.

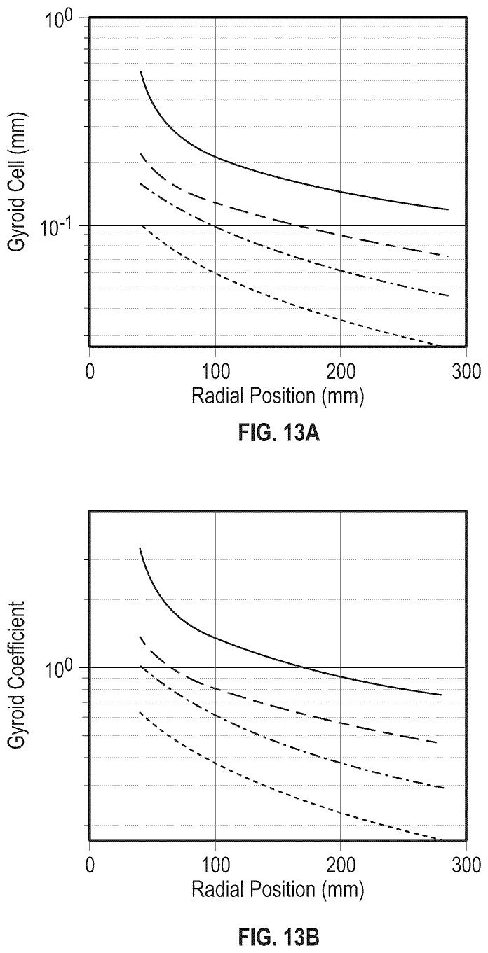

FIGS. 13A and 13B illustrate the relationship between gyroid cell size and radial position and gyroid coefficient and radial position, respectively, for various gyroid structures. As shown in FIG. 13A, as radial position increases, the gyroid cell size decreases. Furthermore, in FIG. 13B, gyroid coefficient decreases as radial position increases.

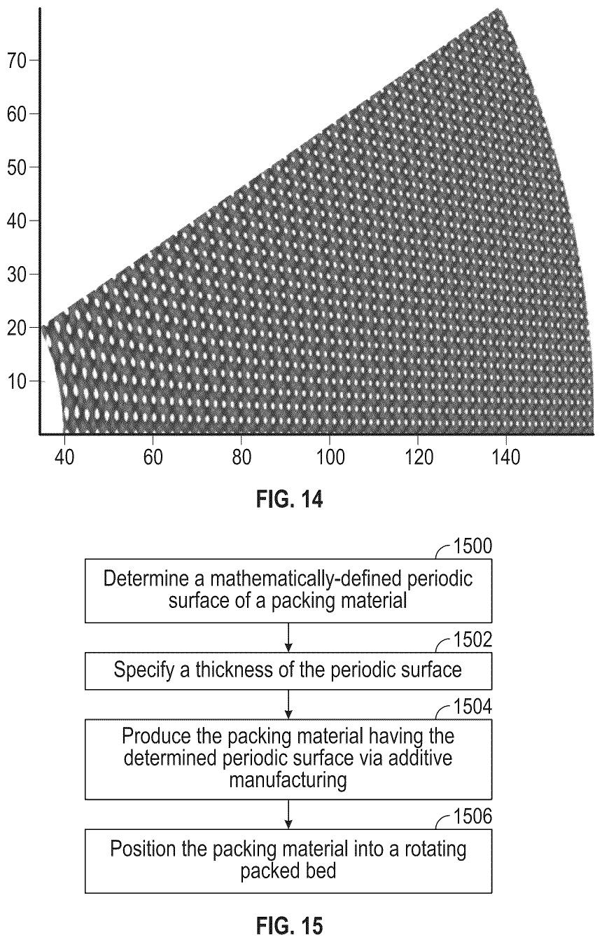

To generate the gyroid geometry, a more complex fit equation may be implemented directly in MATLAB® to create the gyroid surface using an isosurface function. The gyroid surface may be exported as an STL file. An STL file is a standard file type for 3D printing and communicating with 3D printing hardware. The gyroid surface may then be thickened using NX™ software to generate a solid body. FIG. 14 depicts a single wedge structure as an example of a structure that may be created. Wedges may be produced if the printer is not large enough to print an entire packing cylinder/disk.

Besides pressure drop, ensuring a uniform and high degree of wetting/liquid holdup from inner to outer layers of the RPB is important to the RPB's performance. Liquid holdup is the accumulation of liquid in the packed bed, which may impact pressure drop. The geometry and acceleration of the RPB create distinct differences in hydraulics from that of a stationary column. First, due to the shape of an RPB, both packing volume and liquid acceleration (centrifugal) increase along the radial direction (r=\sqrt{X²+Y²}), where

$$V ( r ) = π ( {r}^{2} - {r}_{0}^{2} ) w ; \frac{d V}{d r} = 2 π rw$$

$$g ( r ) = {ω}^{2} r ; \frac{d g}{d r} = {ω}^{2} .$$

Wetting of RPB packing, or liquid holdup, may be described using a film model, derived by Burns (referred to as the Burns correlation for liquid holdup), with contributions from viscous flow (commonly referred to as film flow) and inertial flow (referred to as pore flow):

$${ε}_{L} = {a}_{w} {h}_{A} .$$

The liquid flow regimes are defined by the dominant force slowing their flow. Viscous (film) flow generally dominates at low Reynolds number, and collision limited (pore) flow dominates at high Reynolds number. Because both conditions may be present in the RPB depending on geometry and rotation rate, both film models are considered as follows:

$${h}_{A , visc .} = 2.25 {( \frac{v {U}_{L}}{{a}_{w} g} )}^{1 / 3} ; {h}_{A , pore} = 2.59 \frac{{U}_{L}}{{a}_{w} {g}^{1 / 2} {d}_{P}^{1 / 2}} [ \frac{1 - {( 1 - K )}^{1 / 2}}{{K}^{1 / 2}} ] .$$

Therefore, assuming complete wetting (a_{w}=aₛ), the liquid holdup value may be optimized to be consistent by manipulating the gyroid coefficient A to manipulate the area so that liquid holdup may be constant for the relevant flow regime:

$${( \frac{{a}_{s}}{r} )}_{visc} = const . ; {( \frac{{a}_{s}}{{r}^{3}} )}_{pore} = c o n s t .$$

TABLE 4

| Variable | Measurement |
|---|---|
| r | Distance from center/radial |
| | coordinate |
| w | RPB annulus width (Z-direction) |
| ω | Angular velocity/rotation rate |
| g | Acceleration in the r direction |
| ε_{L} | Liquid holdup |
| a_{w} | Wetted area of packing |
| h_{A} | Effective film thickness |
| ν | Liquid kinematic viscosity |
| U_{L} | Liquid velocity |
| d_{P} | Pore diameter in packing |
| K | Kinetic energy loss |

A liquid holdup value may be determined as a function of the packing density, a gas velocity, a liquid velocity, and a rotational speed. The liquid holdup is fit to one or more periodic equations such that a geometry of the packing is varied to maintain a constant liquid holdup without changing a local superficial gas velocity.

FIG. 15 depicts a flowchart in accordance with one or more embodiments of the present disclosure. More specifically, FIG. 15 illustrates a method for producing a packing material for use in a rotating packed bed. In step 1500, a mathematically-defined periodic surface having an inner diameter and an outer diameter is determined using one or more periodic equations, as described above. In step 1502, a thickness of the periodic surface is specified in order to translate the periodic surface into a three-dimensional solid body. The packing material having the determined periodic surface is produced via additive manufacturing in step 1504. Finally, in step 1506 the produced packing material is positioned into a RPB.

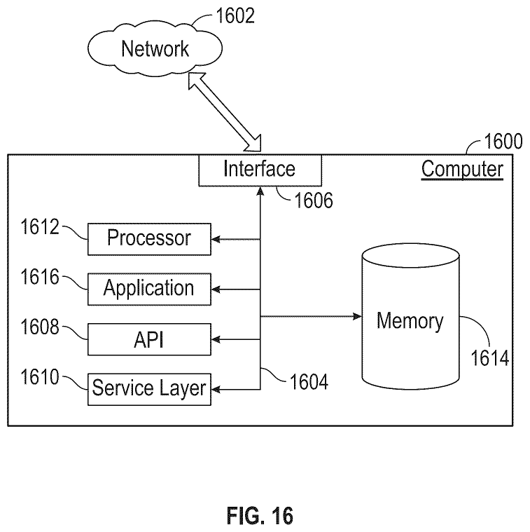

FIG. 16 further depicts a block diagram of a computer 1600 used to provide computational functionalities associated with described analysis, methods, functions, processes, flows, and procedures as described in this disclosure, according to one or more embodiments. The illustrated computer 1600 is intended to encompass any computing device such as a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer 1600 may include an input device, such as a keypad, keyboard, touch screen, or other device that can accept user information, and an output device that conveys information associated with the operation of the computer 1600, including digital data, visual, or audio information (or a combination of information), or a GUI.

The computer 1600 can serve in a role as a client, network component, a server, a database or other persistency, or any other component (or a combination of roles) of a computer system for performing the subject matter described in the instant disclosure. The illustrated computer 1600 is communicably coupled with a network 1602. In some implementations, one or more components of the computer 1600 may be configured to operate within environments, including cloud-computing-based, local, global, or other environment (or a combination of environments).

At a high level, the computer 1600 is an electronic computing device operable to receive, transmit, process, store, or manage data and information associated with the described subject matter. According to some implementations, the computer 1600 may also include or be communicably coupled with an application server, e-mail server, web server, caching server, streaming data server, business intelligence (BI) server, or other server (or a combination of servers).

The computer 1600 can receive requests over network 1602 from a client application (for example, executing on another computer 1600) and responding to the received requests by processing the said requests in an appropriate software application. In addition, requests may also be sent to the computer 1600 from internal users (for example, from a command console or by other appropriate access method), external or third-parties, other automated applications, as well as any other appropriate entities, individuals, systems, or computers.

Each of the components of the computer 1600 can communicate using a system bus 1604. In some implementations, any or all of the components of the computer 1600, both hardware or software (or a combination of hardware and software), may interface with each other or an interface 1606 (or a combination of both) over the system bus 1604 using an application programming interface (API) 1608 or a service layer 1610 (or a combination of the API 1608 and service layer 1610). The API 1608 may include specifications for routines, data structures, and object classes. The API 1608 may be either computer-language independent or dependent and refer to a complete interface, a single function, or even a set of APIs. The service layer 1610 provides software services to the computer 1600 or other components (whether or not illustrated) that are communicably coupled to the computer 1600. The functionality of the computer 1600 may be accessible for all service consumers using this service layer. Software services, such as those provided by the service layer 1610, provide reusable, defined business functionalities through a defined interface. For example, the interface may be software written in JAVA, C++, or other suitable language providing data in extensible markup language (XML) format or another suitable format. While illustrated as an integrated component of the computer 1600, alternative implementations may illustrate the API 1608 or the service layer 1610 as stand-alone components in relation to other components of the computer 1600 or other components (whether or not illustrated) that are communicably coupled to the computer 1600. Moreover, any or all parts of the API 1608 or the service layer 1610 may be implemented as child or sub-modules of another software module, enterprise application, or hardware module without departing from the scope of this disclosure.

The computer 1600 includes an interface 1606. Although illustrated as a single interface 1606 in FIG. 16, two or more interfaces 1606 may be used according to particular needs, desires, or particular implementations of the computer 1600. The interface 1606 is used by the computer 1600 for communicating with other systems in a distributed environment that are connected to the network 1602. Generally, the interface 1606 includes logic encoded in software or hardware (or a combination of software and hardware) and operable to communicate with the network 1602. More specifically, the interface 1606 may include software supporting one or more communication protocols associated with communications such that the network 1602 or interface's hardware is operable to communicate physical signals within and outside of the illustrated computer 1600.

The computer 1600 includes at least one computer processor 1612. Although illustrated as a single computer processor 1612 in FIG. 16, two or more processors may be used according to particular needs, desires, or particular implementations of the computer 1600. Generally, the computer processor 1612 executes instructions and manipulates data to perform the operations of the computer 1600 and any algorithms, methods, functions, processes, flows, and procedures as described in the instant disclosure.

The computer 1600 also includes a memory 1614 that holds data for the computer 1600 or other components (or a combination of both) that can be connected to the network 1602. For example, memory 1614 can be a database storing data consistent with this disclosure. Although illustrated as a single memory 1614 in FIG. 16, two or more memories may be used according to particular needs, desires, or particular implementations of the computer 1600 and the described functionality. While memory 1614 is illustrated as an integral component of the computer 1600, in alternative implementations, memory 1614 can be external to the computer 1600.

The application 1616 is an algorithmic software engine providing functionality according to particular needs, desires, or particular implementations of the computer 1600, particularly with respect to functionality described in this disclosure. For example, the application 1616 can serve as one or more components, modules, applications, etc. Further, although illustrated as a single application 1616, the application 1616 may be implemented as multiple applications 1616 on the computer 1600. In addition, although illustrated as integral to the computer 1600, in alternative implementations, the application 1616 can be external to the computer 1600.

There may be any number of computers 1600 associated with, or external to, a computer system containing computer 1600, wherein each computer 1600 communicates over network 1602. Further, the term “client,” “user,” and other appropriate terminology may be used interchangeably as appropriate without departing from the scope of this disclosure. Moreover, this disclosure contemplates that many users may use one computer 1600, or that one user may use multiple computers 1600.

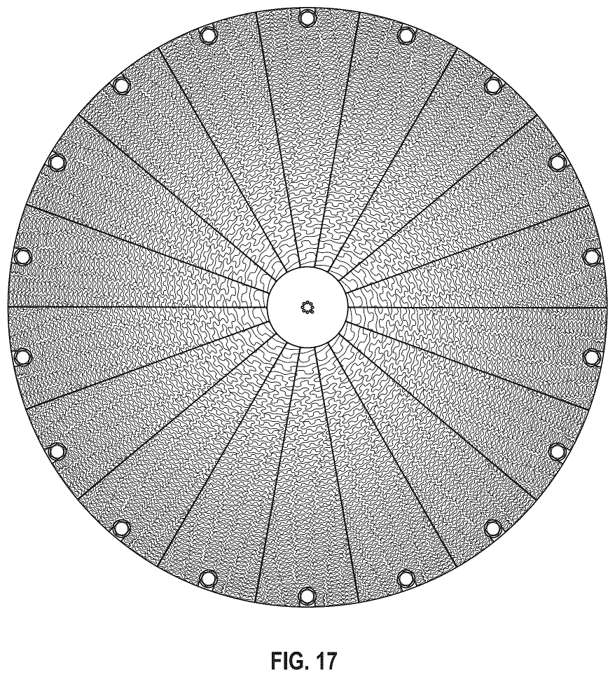

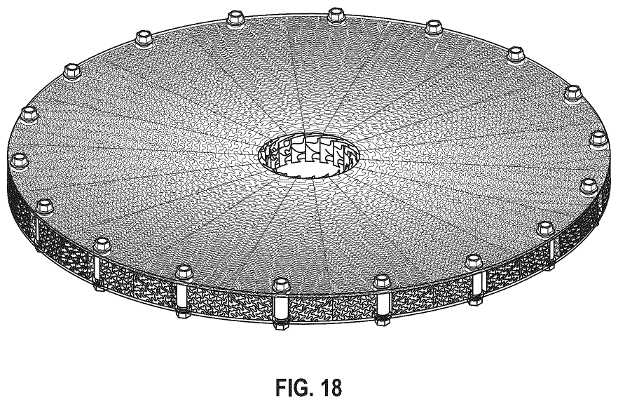

Embodiments of the present disclosure may provide at least one of the following advantages. High specific area, low pressure drop packing may be specifically designed to facilitate CO₂ absorption. Pressure drop per unit length may be maintained through a customized RPB, such as the variable gyroid RPBs depicted in FIG. 17 and FIG. 18. Maintaining pressure drop per unit length allows full utilization of the packing and prevents channeling and maldistribution of gas or liquid on the outer radius, avoiding high pressure drops across the RPB. Another advantage is the implementation of plastic additive manufacturing (e.g., 3-D printing) to reduce the material and manufacturing cost of the packing and provide flexibility for manufacturing highly complex structures and geometries, including packing materials specifically tailored for individual applications. Plastic or metal 3-D printing may also be used to include unique features, such as a texture to improve mixing or surface wetting, or additives, such as activated carbon, which could remove metal contaminants from the solution. For instance, the 3-D printing process may produce artifacts that are not part of the design but are generally assumed to improve performance by promoting gas/liquid contact and spreading of the liquid along the solid surface of the packing. In addition to activated carbon, other additives may include EDTA (or other chelating agents), carbonic anhydrase, borate, or arsenate, which may be incorporated into the surface of the packing.

Furthermore, the nature of the periodic pattern is expected to provide higher mechanical strength with less, or weaker, materials, since the structures are multi-directional and do not contain a weak axis. Therefore, the structures may be more durable for moving systems, such as CO₂ capture systems for transport applications on ground vehicles (e.g., trucks) and ships. Previous work has shown the potential of triply repeating minimal surfaces, such as gyroid and Schwarz, for CO₂ capture. However, using mathematical features of gyroids and other TPMS to produce an optimal packing for a cylindrical RPB absorber in which gas velocity changes dramatically from the inlet to the outlet has not previously been described.

Although only a few example embodiments have been described in detail above, those skilled in the art will readily appreciate that many modifications are possible in the example embodiments without materially departing from this invention. In addition, many modifications will be appreciated by those skilled in the art to adapt a particular instrument, situation, or material to embodiments of the disclosure without departing from the essential scope thereof. Accordingly, all such modifications are intended to be included within the scope of this disclosure as defined in the following claims.

Furthermore, the compositions described herein may be free of any component, or composition not expressly recited or disclosed herein. Any method may lack any step not recited or disclosed herein. Likewise, the term “comprising” is considered synonymous with the term “including.” Whenever a method, composition, element or group of elements is preceded with the transitional phrase “comprising,” it is understood that we also contemplate the same composition or group of elements with transitional phrases “consisting essentially of,” “consisting of,” “selected from the group of consisting of,” or “is” preceding the recitation of the composition, element, or elements and vice versa.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by one or more embodiments described herein. At the very least, and not as an attempt to limit the application of the doctrine of equivalents to the scope of the claim, each numerical parameter should at least be construed in light of the number of reported significant digits and by applying ordinary rounding techniques.

What is claimed:

1. A packing for gas or liquid contacting applications, comprising:
a porous packing material having a plurality of tortuous flow paths from an inner diameter to an outer diameter of the packing material,
wherein the plurality of tortuous flow paths are in a form of a mathematically-defined periodic surface, and
wherein the periodic surface has a packing density that varies from the inner diameter to the outer diameter.

2. The packing of claim 1, wherein the packing density varies continuously from the inner diameter to the outer diameter, and wherein the packing density is higher at the outer diameter than at the inner diameter.

3. The packing of claim 1, wherein the periodic surface is mathematically defined using one or more periodic- or fractal-based equations in which at least one of a surface thickness, a void fraction, a surface area, a liquid holdup, or a pressure drop per unit length is varied.

4. The packing of claim 3, wherein the periodic surface is a triply-periodic minimal surface.

5. The packing of claim 1, wherein the periodic surface has a period ranging from approximately 0.1 millimeters to approximately 10 millimeters.

6. The packing of claim 1, wherein the periodic surface has a specific surface area ranging from approximately 100 m²/m³ to approximately 4000 m²/m³.

7. The packing of claim 3, wherein the periodic surface is defined by a gyroid equation, a Schwarz P equation, a Schwarz D equation, a Neovius equation, a Schoen I-Weaire-Phelan equation, a Fischer-Koch equation with rhombohedral symmetry, or a Schwarz crossed layers of parallel planes surface.

8. The packing of claim 1, wherein a plurality of holes in the porous packing material are aligned such that an axis extending through a set of aligned holes is at an angle between approximately 30° and 60° relative to a direction of gas flow.

9. A method for producing a packing, comprising:
using one or more periodic equations, mathematically defining a periodic surface for a packing having an inner diameter and an outer diameter;
specifying a thickness of the mathematically-defined periodic surface in order to translate the mathematically-defined periodic surface into a three-dimensional solid body; and
producing the packing having the mathematically-defined periodic surface via additive manufacturing,
wherein the packing is comprised of a porous packing material having a plurality of tortuous flow paths from the inner diameter to the outer diameter of the packing material,
wherein the plurality of tortuous flow paths are in a form of the mathematically-defined periodic surface,
wherein a packing density of the mathematically-defined periodic surface varies from the inner diameter to the outer diameter, and
wherein the packing density is greater at the outer diameter than at the inner diameter.

10. The method of claim 9, wherein the packing density varies continuously from the inner diameter to the outer diameter.

11. The method of claim 9, comprising varying at least one of a surface thickness, a void fraction, a specific surface area, a liquid holdup, and a pressure drop per unit length of the packing in a direction of fluid travel.

12. The method of claim 9, wherein the one or more periodic equations comprises one or more of a gyroid equation, a Schwarz P equation, a Schwarz D equation, a Neovius equation, a Schoen I-Weaire-Phelan equation, and a Fischer-Koch equation with rhombohedral symmetry, and a Schwarz crossed layers of parallel planes surface.

13. The method of claim 9, wherein the periodic surface is a triply-periodic minimal surface.

14. The method of claim 9, wherein the periodic surface is a fractal pattern selected from the group consisting of a Menger sponge, a Sierpinski tetrahedron, a Voronoi tessellation, a Kelvin cell, and a dendritic structure.

15. The method of claim 11, wherein a permeability, the pressure drop, and the liquid holdup of the periodic surface are estimated using a Kozeny-Carman equation, a Darcy-Forchheimer equation, and a Burns correlation, respectively.

16. The method of claim 9, comprising:
determining a pressure drop per unit length as a function of the packing density and a superficial gas velocity; and
fitting the pressure drop per unit length to the one or more periodic equations such that a geometry of the packing is varied to maintain a constant pressure drop.

17. The method of claim 9, comprising positioning the packing inside of a cylindrical rotating packed bed such that an interfacial area between two fluid phases is created, wherein at least one of the fluid phases passes radially through the cylindrical rotating packed bed, transiting from the inner diameter to the outer diameter, or from the outer diameter to the inner diameter.

18. The method of claim 9, comprising:
determining a liquid holdup as a function of the packing density, gas velocity, liquid velocity, and rotational speed; and
fitting the liquid holdup to the one or more periodic equations such that a geometry of the packing is varied to maintain a constant liquid holdup without changing a local superficial gas velocity.
